(19) United States
(12) Patent Application Publication
(10) Pub. No.: US 2002/0145350 A1
(43) Pub. Date: Oct. 10, 2002

(54) Pressure to electric converter PEC

(76) Inventor: Gary Allen Henderson, New York, NY (US)

Correspondence Address: Gary Henderson, PO Box 2131, New York, NY, 10025, US

(21) Appl. No.: 09/756,006

(22) Filed: Jan. 8, 2001

(51) Int. Cl. H02K 16/00; H02N 2/00

(52) U.S. Cl. 310/112; 310/339

(57) ABSTRACT

The PEC is utility device designed to convert intermittent pressure into electrical charges. It may be implemented in a variety of forms. The easiest to describe is the mechanical floor plate. It consists of depress-able track mounted plates with small barrel electrical generators attaches to the bottom and geared to turn downward step pressure into rotational energy for the generators. This implementation is inexpensive to manufacture, as it uses off the shelf components, and would be ideal in third world applications where components are difficult to obtain. It would be useful in animal movement applications, like the herding of livestock for transport or processing. The current generated is stored in a separate battery assembly, and the flooring is designed to lock together on all four sides with the electrical transport channel outlets available on all sides as well.

The piezoelectric implementation can be implemented with piezoelectric film or ceramics, the relevant design considerations are for step comfort and trip avoidance. Both of these considerations are addressed by the choice of materials for the top insulating plate, and a beveling of edges of the same.

### CROSS REFERENCE TO RELATED APPLICATIONS

None

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION:

Statement of the field of endeavor:

Over the history of mankind people have sought to convert energy from a naturally occurring state to a more useful form. From our first use of draft animals for cultivation, to our efforts to convert the energy contained in atomic structures, all represent our desire to make useful naturally occurring energy. Pressure has almost always been a central element in these efforts. In the use of draft animals, the pressure exerted by the animal on a harness, and in atomic power pressure from heated fluid is used to generate electric power.

Pressure occurs naturally as a by product of most events, and is a factor in most if not all forms of energy generation. The phenomena of pressure when combined with a natural or imposed cyclic effect are the essential elements of electrical production. We have seen these elements combined to convert water, wind, thermal, and other types of noticed power in to useful electrical energy.

Problems with current state of the art addressed by this utility:

The apparent problems with all of the above described pressure sources are availability, cost, and application. The pressure must be captured far from where it will be used. Often the pressure must be generated by the intervention of other systems or devices, i.e. burning, animal control, or hose as the capture medium, the hose is filled with fluid, which is forced out by the pressure source. 2. {PCR} PC reset system: A reset mechanism to return the {PC} to its original state, to facilitate the next cycle of pressure capture. For the plate based system this reset system can consist of springs or hydraulics, which simply push to plate back to its non depressed state, once the pressure has been removed. In the hose based {PC}, the natural force of gravity and suction, which can be augmented by design, will return the hose back to its non depressed state. Note: The need for this element of the system, is dictated by the electrical generation methods known to me at this time, and may be unnecessary with future implementation of this system. 3. {IPTEC} Pressure to electric conversion system: A system to convert the pressure captured by the {PC} into electrical charges. In the plate based system described above the pressure is converted in rotational force by the method of a standard axial generator mounted on the bottom surface of the {PC }, with a circular cog moving in a toothed track which causes the axis or spindle of the generator to rotate thereby generating and electrical current or charge. This method is also used in the hosed based system, in that the fluid forced out of the hose, by the pressure source, is used to propel a turbine, which in turn rotates the axis or spindle of a generator, producing an electric charge or current. An alternate, to the use of mechanical generators, is to employ piezoelectric materials which will generate and electrical charge from pressure. The piezoelectric materials would be used in the {PTEC} Pressure to electric conversion system to replace mechanical generators. 4. {EPDB} Excess Pressure Distribution Base: The final element is only utilized in the plate based systems, not in the hose implementation. It consists of a supporting base, which acts as the support for the {PCR}, and also serves to distribute pressure that has not been converted to the underlying support structure. In most cases it will be comprised of a rigid load bearing material such as metal, rubber or plastic. This element of the utility will also be important in easing the spongy feeling that animal traffic will experience when they encounter a surface utilizing a PEC.

In the prototype piezoelectric implementation, springs are used in the inner energy conversion assembly to return the top insulating plate to the its uncompressed state after each step. The prototype piezoelectric assembly consist of two pieces of wood as the rigid insulating plates, and six individual piezoelectric elements wired to send the resulting sparks to a basic battery charger. The gap required for compression and de-compression of the piezoelectric elements is maintained by coil springs. In a production version, a piezoelectric film or similar element would most likely be used.

The assembled system will consist of each of the above listed components as needed for a specific implementation. For example the plate based system, either permanent or temporary will consist of the following;

The capture method consists of inserting a PEC device between the source of intermittent pressure and a rigid surface. The pressure generated by steps, in the form of periodic increased weight on the PEC, {i.e. foot steps, moving animals, etc.}, is converted either by piezoelectric, compressible gas/fluid filled bladders or hose, or mechanical conversion of downward pressure into rotation. The captured energy may be used directly or stored for future use.

Statement of Utility:

A PEC when attached to foot or hoof is particularly useful in the supply of electric current or energy to portable devices, for example; audio devices, communications devices, computing equipment, and thermal maintenance systems. When the PEC is used as flooring it is useful in the conversion of energy generated by vehicular traffic, pedestrian traffic or animal herding. When PEC's are applied to the a vehicle roadway, energy can be captured from the intermittent weight of passing vehicles. This captured energy can be used to power road or walk side devices such as signs or lights.

### BRIEF DESCRIPTION OF THE SEVERAL VIEWS OF THE DRAWING

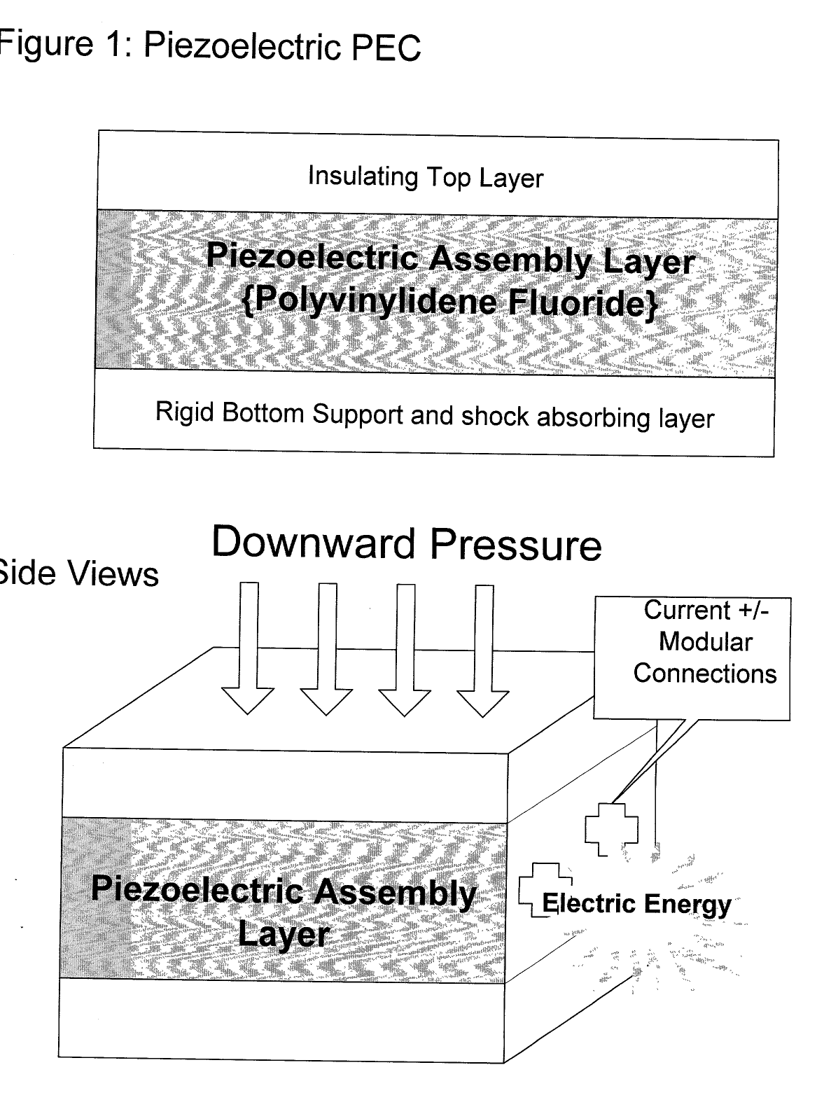

1. FIG. 1: Piezoelectric PEC - Side views of PEC device constructed with piezoelectric elements as the generating method.

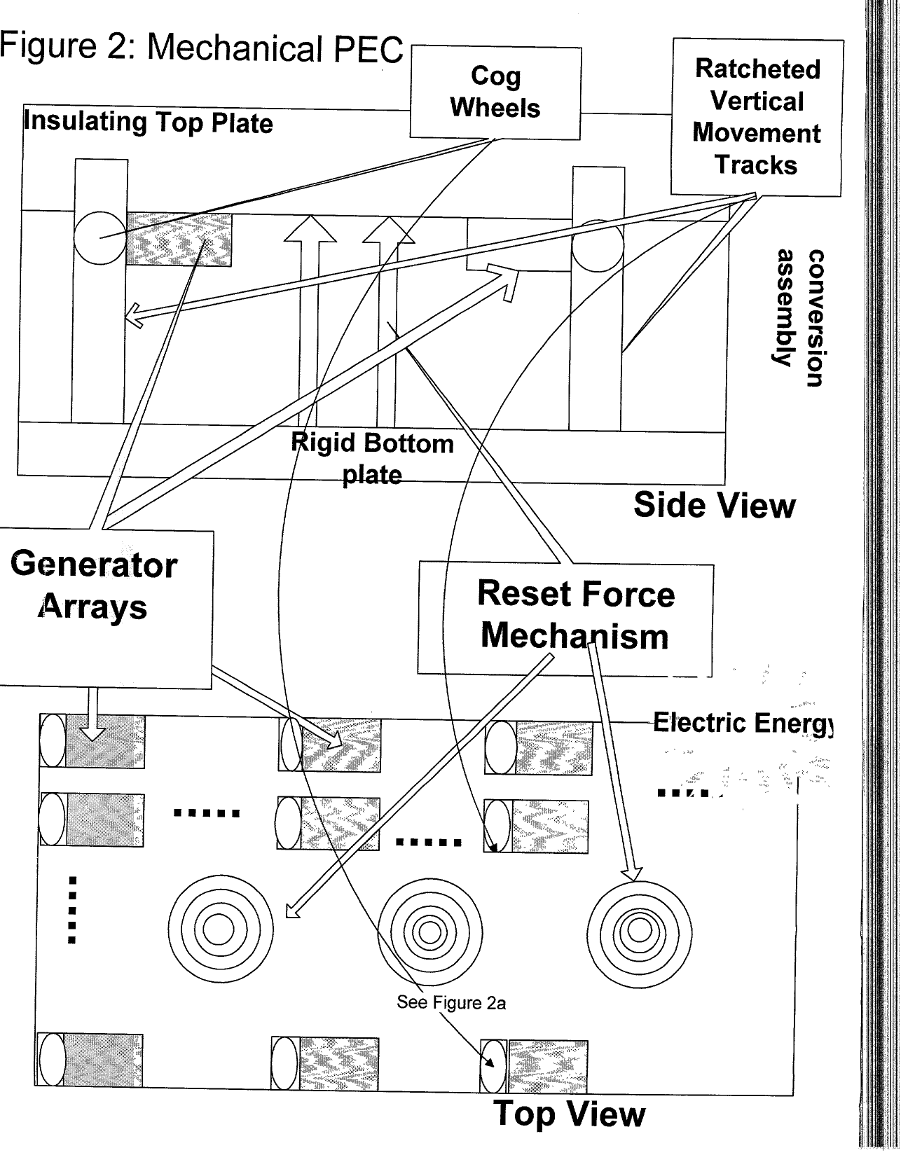

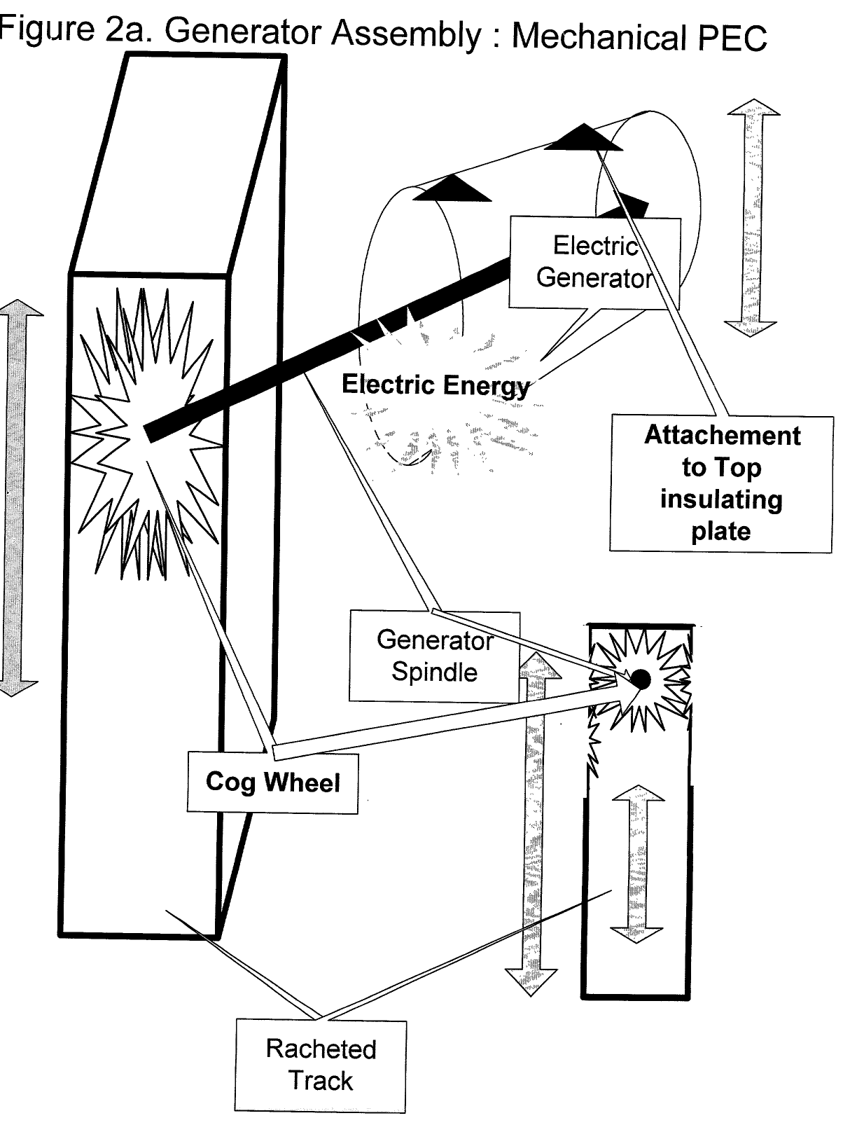

2. FIG. 2: Mechanical PEC - Side and top views of PEC device employing mechanical rotating generators, with ratcheted wheels converting pressure into rotation.

3. FIG. 2a: Mechanical PEC - Generator with ratcheted wheels and track for systematic conversion of pressure into rotational energy

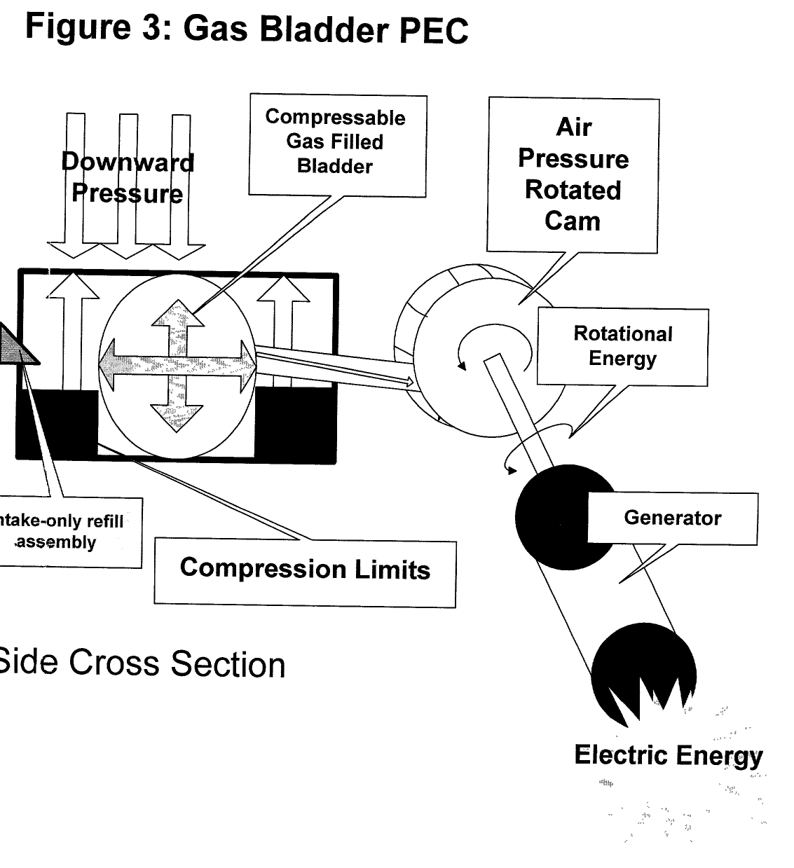

4. FIG. 3: Gas Bladder PEC - Side and general assembly views of device to convert pressure on flexible gas filled bladder into rotational energy.

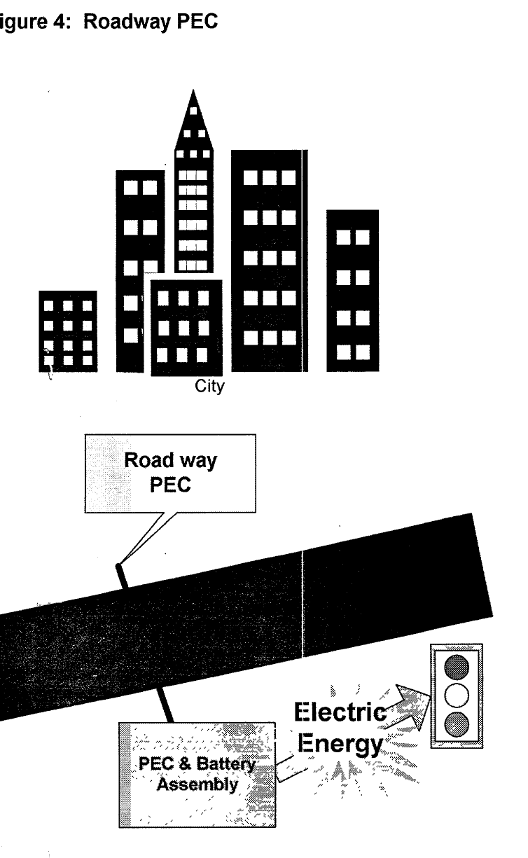

5. FIG. 4: Roadway PEC: Application of PEC device to power roadside devices with the pressure generated by vehicular traffic.

### DETAILED DESCRIPTION OF THE INVENTION

A PEC {pressure to electric converter} is one of a variety of implementations of my design which converts intermittent pressure into electrical energy. It consists of a system which uses pressure from an intermittent source, such as animal steps, or vehicle movement to generate electrical energy. The basis elements of this design are; 1. {PC} pressure capture system: A system to capture energy that would normally be released or expended into a surface, such as the ground or floor. For animal steps this system can consist of a depressable plate, which is depressed by the pressure of each step. For vehicle systems, a depressable hose or plate system would be used. In the use of the conversion. Where fuels are necessary they must be stored, transported, and purchased thereby causing additional cost of energy.

USPTO Classification: ELECTRICITY: SINGLE GENERATOR SYSTEMS: Automatic in response to predetermined conditions

The most common sources of cyclical or intermittent pressure has been largely untapped. This source is the movement of significant weight from point to point, usually for some more apparent purpose such as transport or movement.

The pressure of a walking human, amounting to 1/2million pounds daily for a average adult, can be converted into a electricity A walking animal has the two natural elements necessary for electrical power generation, significant pressure and a natural cyclic or intermittent presence. This is also true of vehicles.

Other inventors have sought to utilize the elements of pressure, or movement for the generation of electrical energy. However, my review of existing patents, and general literature does not reveal any device, utility or system which successfully converts this most common of naturally occurring power into generally useful electrical energy.

During my review of existing patents, I found USPO#5,818,132, to be similar in its basic objective, but fundamentally different in basic principle. The device referred to in 5,818,132 depends on the cyclic or intermittent nature of walking as its energy source to generate an electric charge through its design. Our utility as described in this application uses pressure as its energy source. Although movement is an element of my design it is only one of the elements necessary to achieve repetitive pressure. A simple comparative analysis of the two devices show that in 5,818,132, the step of a 50 lb. child would have the same energy generating potential, as would a 500 lb man. While with my utility there would be a 10 fold increase in the potential energy of each step.

### BRIEF SUMMARY OF THE INVENTION:

Pressure to Electric Converter PEC is a device that captures the intermittent energy expended as pressure on a surface, and converts captured energy into an electric charge. The primary objective of this device is to scavenge the energy of movement, which is normally expended into the supporting surface, {i.e. The ground, the floor, the roadway, etc}. During the process of moving any object of substantial weight, from one point to another, a substantial amount of energy is expended. This energy is expended by animals as they walk on a surface. Energy is also expended as vehicles are moved over a floor or roadway. The PEC is a device design which can be used in any of the above described instances, to capture or scavenge the energy of the targeted process.

| | |
|---|---|
| {PC} pressure capture | Padded rigid plate, rail mounted to allow |
| system | vertical depression, with minimal horizontal |
| | axis distortion. |
| {PCR} PC reset system | Coiled springs mounted between the {PC} |
| | and the {EPDB}. With minimum vertical |
| | height determined by stops on the rail system |
| | of the {PC}. And maximum vertical height |
| | determined to return the {PC} to its original |
| | position. |
| {PTEC} Pressure to | An array of small barrel type electro-magnetic |
| electric conversion | generators, mounted to the underside of the |
| system | {PC}. Attached to a cog, which is rotated by |
| | a ratchet action as the attached generators are |
| | move downward by pressure placed on the |
| | {PC}. A suitable circuit for delivering the DC |
| | charge to an external socket, which is |
| | attached to an external collection system for |
| | use. |
| {EPDB} Excess Pressure | A rigid base which can withstand repeated |
| Distribution Base | cycles of spring compression, while |
| | minimizing horizontal distortion. |

In most implementations the unit is designed to interlock with other units to comprise a larger flooring area. The pressure of animal steps is captured by various means, depending upon the application, material availability, and the efficiency of the materials. The modular design of the units considers efficiency, durability, ease of assembly, and a variety of ergonomic factors such as step comfort and trip minimization. Conduits are provided for channeling converted or captured energy to external storage facilities.

1. A PEC is an electric power generator which converts the naturally intermittent pressure of moving weight from one point to another, into electrical energy.
a. This energy can be used directly or stored in a battery system for future usage.
b. The utility can be implemented either as a fixed, portable or attachable system.
i. A fixed implementation of this utility would be used as semi-permanent flooring or roadway surface. A collection and storage system would then be used to present the converted energy in a more useful format.
ii. A portable implementation of this utility would be used as temporary flooring, to convert the intermittent pressure sources. As an alternative the hose/bladder design could be used, for example: Gas/Fluid filled hose/bladder placed across a roadway to convert the pressure from automobile traffic in to electric charges.
iii. An attachable implementation, designed for attachment to a foot or rotating wheel, would intermittently be depressed, and reset by the natural movement of the target process. In the case of an attachable PEC for use on the human foot, PEC devices would be placed at the major pressure points, primarily the heel and ball of the foot. The device could be either directly integrated into a shoe sole, or fixed with some method of belting glueing, or other acceptable means.

2. A PEC is an electric power generator which converts the intermittent pressure of vehicle movement, as during regular motor traffic on a permanent or temporary roadway. This energy can be used directly or stored in a battery system for future usage.

3. A PEC device consists of a rigid bottom and top insulating plates, and an inner assembly that performs the energy conversion. A PEC can be made from a variety of different materials, with minor design changes.
